(19) United States
(12) Patent Application Publication
(10) Pub. No.: US 2010/0208623 A1
(43) Pub. Date: Aug. 19, 2010

(54) METHOD AND DEVICE OF ASSIGNING RING IDENTIFIER

(75) Inventor: Shinya Kano, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/765,091

(22) Filed: Apr. 22, 2010

Related U.S. Application Data
(63) Continuation of application No. PCT/JP2007/070937, filed on Oct. 26, 2007.

(51) Int. Cl. H04L 12/28

(52) U.S. Cl. 370/258

(57) ABSTRACT

A control message having stored therein a link identifier for identifying a link such as a fiber or cable and a ring identifier for identifying a ring (or a control message having stored therein a ring identifier) is transmitted to a neighbor node. A ring identifier preliminarily assigned to a link identified by the link identifier received from the neighbor node (or a ring identifier preliminarily assigned to a link having received the control message) is compared with a ring identifier received from the neighbor node to select either one of the ring identifiers according to specified selection criteria. The ring identifier selected is assigned to the link identified.

### CROSS-REFERENCE TO RELATED APPLICATION

This application is a continuation of International Application PCT/JP2007/70937 filed on Oct. 26, 2007, the contents of which are herein wholly incorporated by reference.

### FIELD

The present invention relates to a method and device of assigning identifiers to rings in a ring-shaped network.

### BACKGROUND

A large number of transmission networks have adopted a configuration having a plurality of ring networks R1 and R2 (hereinafter, occasionally referred to simply as a ring) as depicted in FIG. 14 for the preparation of a fault, in which the rings R1 and R2 are connected with a duplex line L.

In such a network as depicted in FIG. 15, when establishing a path for transferring data from a node N11 within the ring R1 to a node N26 within the ring R2, the path is established by selecting a route rt1 having a minimum number of rings through which the data pass as depicted by a thick line in FIG. 15. The reason is that even though the path passes through only a portion of a ring, substantially a full bandwidth around a ring is required including a protection route, so that by selecting a route having a minimum number of rings through which the data pass, it is required to establish a path consuming a minimum network resource.

Namely, the opposite side of the ring arc of the working route rt1 within the ring R1 is used as a protection route rt2, so that a network resource (bandwidth) is also reserved on the protection route rt2. On the other hand, the data pass through the ring R2 when selecting a route rt3 depicted by dotted lines, so that a network resource is also reserved for its protection route rt4 with respect to the data on the ring R2. Accordingly, the route rt1 requiring a less network resource than the route rt3 is to be selected and established.

For retrieving such a route, an extension of routing protocol has been proposed (see e.g. a non-patent document: V. Sharma, A. Das and C. Chen, “Leveraging IP signaling and routing to manage UPSR-based transport networks,” in IEEE International Conference on Communications, 2003, ICC, '03, vol. 2, pp. 1268-1272, IEEE, May 2003). In this routing protocol, each node advertises a connection state or available resource of a link (optical fiber or cable; hereinafter, occasionally referred to simply as fiber). Together with this, a ring identifier (hereinafter, occasionally referred to as a ring ID) is advertised as one of the attributes of the fiber. For example, as depicted in FIG. 16, by assigning in advance the ring ID=R1 to a fiber between the nodes N11 and N12, advertising information AD1 including the ring ID=R1 is advertised to the fiber between the nodes N11-N12. To the other fibers, advertising information AD2-AD6 and unshown advertising information are assigned, whereby each node can recognize which fiber belongs to the ring and belongs to which ring.

As a reference document, there are network, a communication apparatus and a route searching method, in which path information management tables in nodes hold information on paths set on the network; link information management tables are extended to have the corresponding path information as to a tunnel; link/path information advertisement processing parts are used so that either or both of an initiator node at the start point of a path and a terminator node at the end point of a path transmit and exchange information of the path or/and information of the link; route calculation processing parts calculate a route from the initiator node to the terminator node during path setting (see e.g. Japanese Laid-open Patent Publication No. 2006-60337).

As a further reference document, there is a communication controller arranging a control node having functions of updating packet transfer control information in response to a control packet transmitted from a user terminal prior to data communication and broadcasting (advertising) the updated packet transfer control information to other nodes in a packet communication network (see e.g. Japanese Laid-open Patent Publication No. 2005-244405).

While in the above non-patent document each node can automatically collect a ring IDs of fibers, it is necessary to assign ring IDs to all of the fibers in advance, so that it disadvantageously requires time and labor for the setting.

### SUMMARY

According to an aspect of the invention, a method (or a device) of assigning ring identifier includes: transmitting (or a portion to transmit) a control message having stored therein a link identifier for identifying a link and a ring identifier for identifying a ring to a neighbor node; selecting (or a portion to select) either one of a ring identifier preliminarily assigned to a link identified by the link identifier received from the neighbor node and a ring identifier received from the neighbor node according to specified selection criteria; and assigning (or a portion to assign) the ring identifier selected to the link identified.

Alternatively, a method (or a device) of assigning ring identifier according to another aspect of the invention may include: providing (or a portion to provide) a control message having stored therein a ring identifier to a neighbor node; selecting (or a portion to select) either one of a ring identifier preliminarily assigned to a link having received the control message and a ring identifier in the control message according to specified selection criteria; and assigning (a portion to assign) the ring identifier selected to the link identified.

An initial value of the ring identifier may include a node identifier or a node identifier+a local interface identifier, and the specified selection criteria may include criteria for selecting a larger one or a smaller one of the node identifier or a node identifier+a local interface identifier.

The control message may include a Link Summary Message based on a Link Property Correlation function of a Link Management Protocol.

Also, the control message may include a test message based on a Link Verification function of a Link Management Protocol.

The ring identifier may be provided by a network manager together with a flag indicating a priority or a validity/invalidity thereof and then stored in the control message; and the selecting (or the portion to select) may include selecting (or a portion to select) the one of the ring identifiers according to the specified selection criteria in view of the priority or flag stored in the control message.

The object and advantages of the embodiment will be realized and attained by means of the elements and combinations particularly pointed out in the claims.

It is to be understood that both the foregoing general description and the following detailed description are exemplary and explanatory and are not restrictive of the invention as claimed.

### BRIEF DESCRIPTION OF THE DRAWINGS

FIG. 1 is a block diagram depicting an arrangement for a method and device of assigning ring identifier;

FIG. 2 is a flow chart depicting a ring ID transmission procedure 1 in an operation example [1] of a method and device of assigning ring identifier;

FIG. 3 is a flow chart depicting a ring ID update procedure 1 in an operation example [1] of a method and device of assigning ring identifier;

FIG. 4 is a chart depicting a format example 1 of LMP Link Summary Message used in an operation example [1] of a method and device of assigning ring identifier;

FIG. 5 is a diagram depicting an associated operation within a node in an operation example [1] of a method and device of assigning ring identifier;

FIG. 6 is a flow chart depicting a ring ID transmission procedure 2 in an operation example [2] of a method and device of assigning ring identifier;

FIG. 7 is a flow chart depicting a ring ID update procedure 2 in an operation example [2] of a method and device of assigning ring identifier;

FIG. 8 is a chart depicting a format example of LMP test message by Link Management Protocol used in an operation example [2] of a method and device of assigning ring identifier;

FIG. 9 is a network diagram for describing an operation example [3] of a method and device of assigning ring identifier;

FIG. 10 is a network diagram for describing an operation example [4] of a method and device of assigning ring identifier;

FIG. 11A is a chart depicting a format example 2 of LMP Link Summary Message used in an operation example [4] of a method and device of assigning ring identifier, and FIG. 11B is a chart depicting priority of determining ring ID;

FIG. 12 is a network diagram for describing an operation example [5] of a method and device of assigning ring identifier;

FIG. 13 is a chart depicting a format example 3 of LMP Link Summary Message used in an operation example [5] of a method and device of assigning ring identifier;

FIG. 14 is a network diagram depicting a general arrangement of a ring network;

FIG. 15 is a network diagram depicting a general path establishing route in a ring network; and

FIG. 16 is a network diagram depicting an advertising state of topology information of a non-patent document.

### DESCRIPTION OF EMBODIMENTS

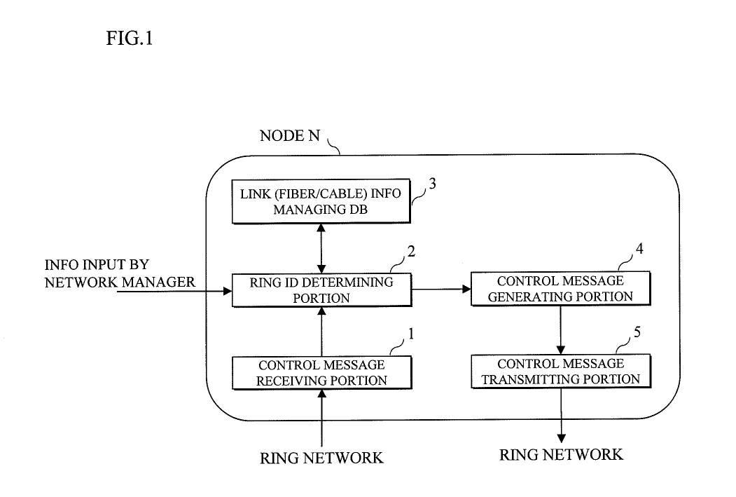

### *Arrangement of Each Node: FIG. 1

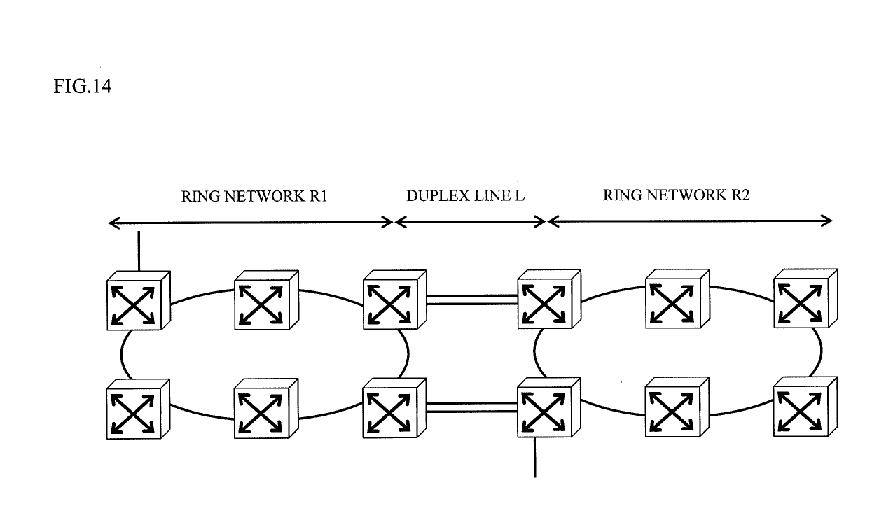

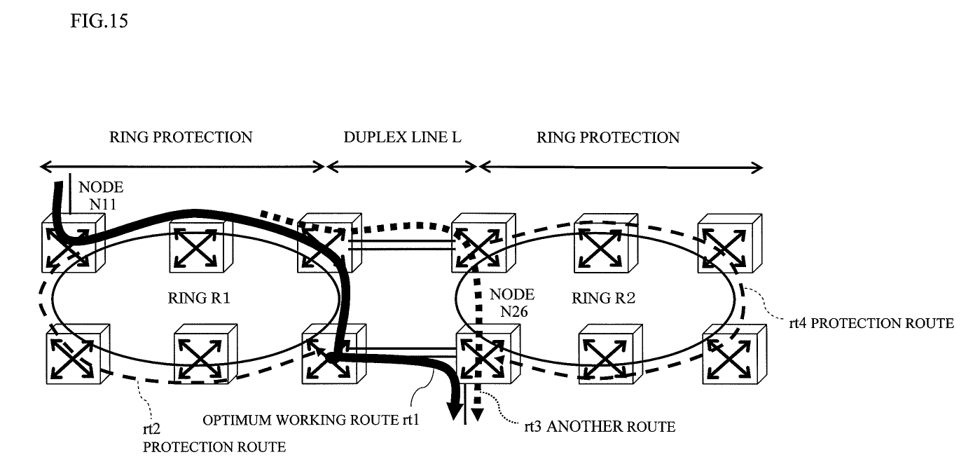

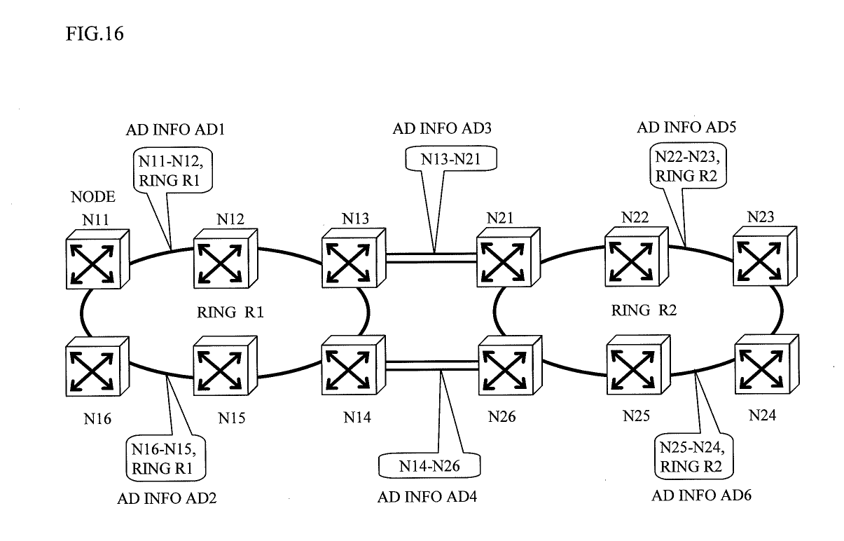

In a ring network as depicted in FIGS. 14-16 aforementioned, a method and device of assigning ring identifier according to the invention are realized by a node N having an arrangement depicted in FIG. 1, composed of the following elements:

### 1: Control Message Receiving Portion

Receives a control message from a ring network.

### 2: Ring ID Determining Portion

Compares a ring ID (ring identifier) received at the control message receiving portion 1 with a ring ID of this node itself (node concerned) preliminarily assigned and stored in a link (link: fiber/cable) information managing database (DB) 3 to determine (select) a ring ID based on specified or predetermined selection criteria; assigns the ring ID determined to a fiber and stores it in the information managing database 3; and as necessary, accepts the ring ID and priority information (or flag indicating validity/invalidity) from a network manager (not depicted) to determine the ring ID.

### 3: Link Information Managing Database (DB)

Stores information for identifying a fiber (link identifier; hereinafter, occasionally referred to as a fiber identifier or fiber ID), node identifier (node ID) and a ring ID from the ring ID determining portion 2, where as necessary, priority information (or a flag indicating validity/invalidity) is stored.

### 4: Control Message Generating Portion

Generates a control message having stored therein a ring ID determined by the ring ID determining portion 2, where in the control message, as necessary, information for identifying a fiber (link ID) and priority information (or flag indicating validity/invalidity) is stored.

### 5: Control Message Transmitting Portion

Transmits the control message generated by the control message generating portion 4 to the ring network.

### Operation Example [1]

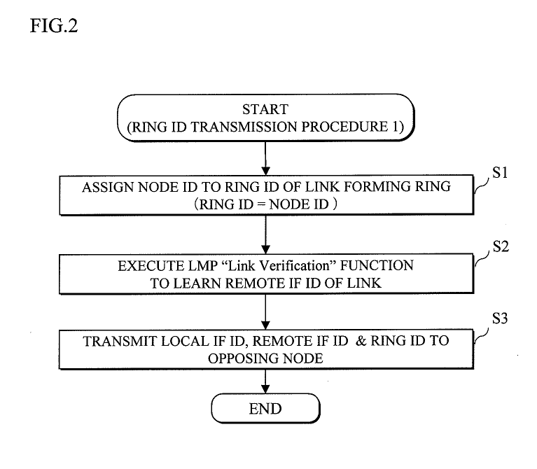

### FIGS. 2-5

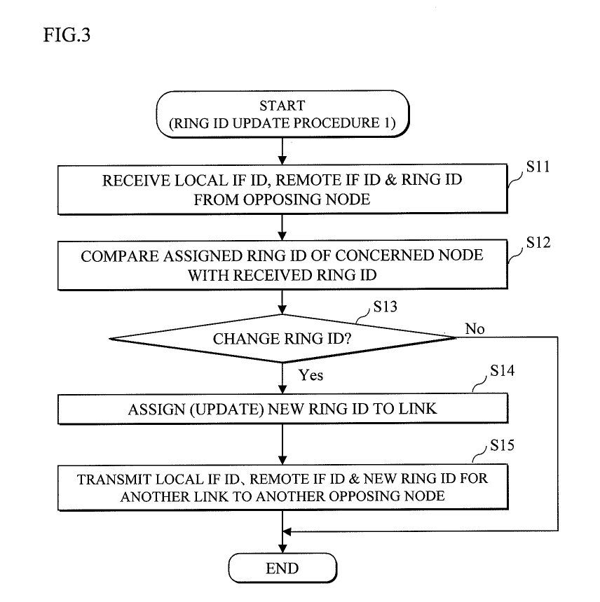

The node N depicted in FIG. 1 operates along flow charts depicted in FIGS. 2 and 3.

### <Ring Id Transmitting Procedure 1: FIG. 2>

First, FIG. 2 depicts the following transmitting operation right after the start-up.

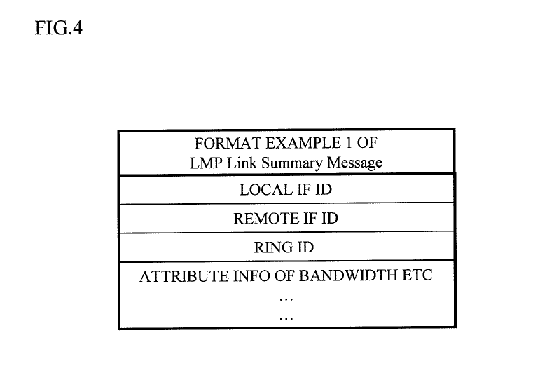

Step S1: As a ring ID of two fibers on each side of each node (logically two fibers and physically four fibers), its own node ID (initial value) is preliminarily assigned and stored in the information managing database 3, where for this node ID, an IP address for example is used.
Step S2: “Link Verification” function of LMP (Link Management Protocol) is started up. By this Link Verification function, a test message (control message) having stored therein a local interface (IF) ID of this node to which a fiber is connected is transmitted from the control message generating portion 4 through the control message transmitting portion 5 to the fiber. When this test message is received by the control message receiving portion 1, a local IF ID of a fiber having received the test message is stored as a remote IF ID by the control message generating portion 4 in the test message to be returned. As a result, association or correspondence between the local IF ID and the remote IF ID of the fiber can be recorded in the information managing database 3, that is a known processing.
Step S3: “Link Property Correlation” function of LMP is started up. By this Link Property Correlation function, the combination of the local IF ID and the remote IF ID that is a fiber identifier obtained at the above step S2 and the attribute information of the fiber (support protocol, bandwidth etc.) are read out of the link information managing database 3, stored in a Link Summary Message as a control message depicted in FIG. 4 by the control message generating portion 4 and transmitted to a neighbor node. At this time, a ring ID assigned at step S1 as one of the fiber attribute information is added to the Link Summary Message to be transmitted.

### <Ring ID Update Procedure 1: FIG. 3>

FIG. 3 depicts the following ring ID update operation at the time of receiving Link Summary Message.

Step S11: The Link Summary Message (control message), depicted in FIG. 4, having stored therein the local IF ID, remote IF ID and ring ID at the above step S3 is received at the control message receiving portion 1.
Step S12: The ring ID determining portion 2 extracts the local IF ID and remote IF ID from the Link Summary Message received and reads the ring ID of the corresponding fiber out of the link information managing database 3 to be compared with the ring ID extracted from the Link Summary Message received. As a result, according to specified selection criteria, the ring ID having a larger value for example is selected.
Step S13: Namely, if the ring ID received is smaller and so is not selected, the processing will end; if the ring ID received is larger, the ring ID determining portion 2 further executes the following steps in order to update the ring ID to a new ring ID.
Step S14: A new ring ID received is assigned to the fiber.
Step S15: The control message generating portion 4 starts up the “Link Property Correlation” function of LMP and stores a fiber identifier (local IF ID and remote IF ID) already obtained with respect to the other neighbor node forming the ring and the ring ID assigned at step S14 in the Link Summary Message to be transmitted to the neighbor node from the control message transmitting portion 5, where another attribute information may be transmitted together.

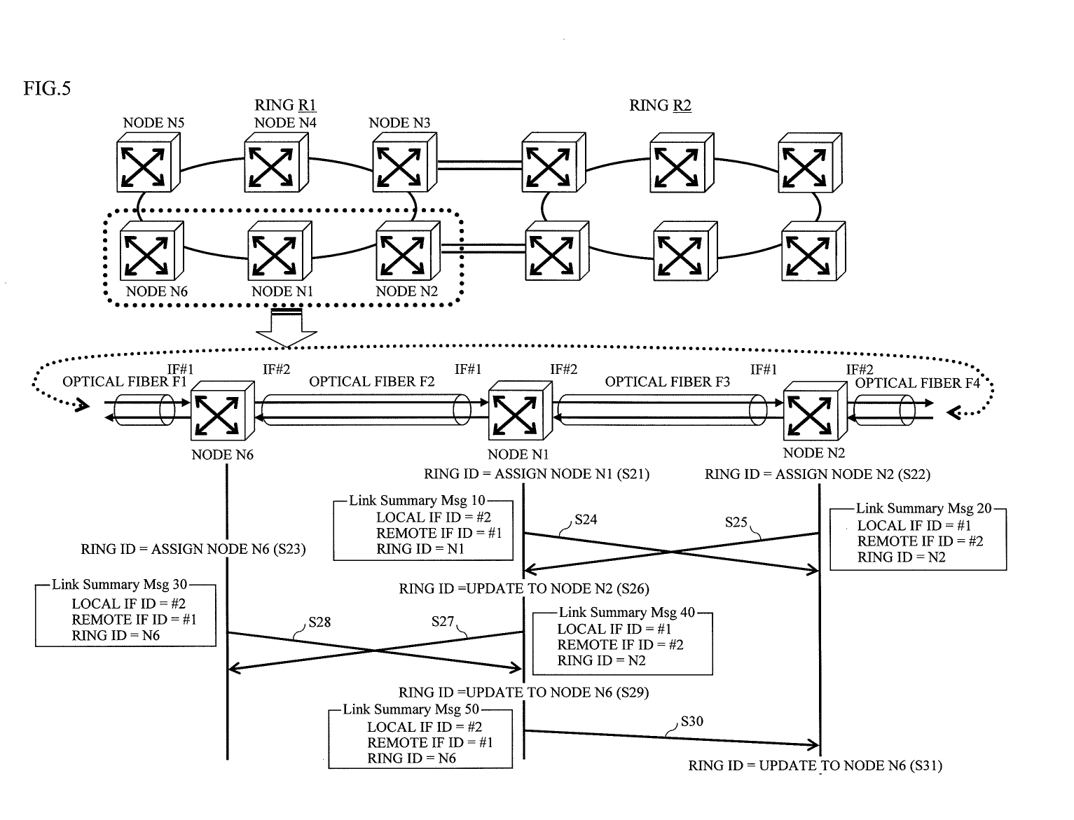

### <Associated Operation Example Between Nodes: FIG. 5>

How the above steps are executed at each node on the network will now be described referring to FIG. 5, where the example depicts a manner how the nodes N1, N2 and N6 on the same ring network as FIGS. 14-16 assign the ring ID to the fibers.

Step S21: The node N1 assigns its own node ID (N1), i.e. node ID of the node N1 itself to the fibers F2 and F3 as the ring ID, which corresponds to step S1 in FIG. 2.
Step S22: Similarly, the node N2 assigns its own node ID (N2) to the fibers F3 and F4 as the ring ID, which also corresponds to step S1 in FIG. 2.
Step S23: Similarly, the node N6 assigns its own node ID (N6) to the fibers F1 and F2 as the ring ID, which also corresponds to step S1 in FIG. 2.
Step S24: The node N1 stores the fiber identifier (local IF ID=#2; remote IF ID=#1) and the ring ID=N1 already acquired by the Link Verification operation (not depicted) at step S2 in FIG. 2 in the Link Summary Message 10 to be transmitted to the neighbor node N2, where the same information is also transmitted to the node N6 while not depicted in operation, which corresponds to step S3 in FIG. 2.
Step S25: The node N2 stores the fiber identifier (local IF ID=#1; remote IF ID=#2) already acquired by the above noted Link Verification operation (not depicted) and the ring ID=N2 in the Link Summary Message 20 to be transmitted to the neighbor node N1, where the same information is transmitted to the node N3 as well while not depicted, which also corresponds to step S3 in FIG. 2.
Step S26: The node N1 compares the ring ID=N2 stored in the Link Summary Message 20 transmitted from the node N2 with the ring ID=N1 (initial value) assigned to the fiber F3 by the node N1 itself. Supposing that by the specified selection criteria a larger node ID is adopted as the ring ID and N1<N2 is found, the node N1 updates the ring ID to “N2”, which corresponds to step S14 in FIG. 3.

On the other hand, the node N2 compares the ring ID=N1 stored in the Link Summary Message 40 transmitted from the node N1 with the ring ID=N2 assigned to the fiber by the node N2 itself. Since N1<N2 is found, the ring ID is not updated, which corresponds to step S13 in FIG. 3.

Step S27: The node N1 stores the above noted fiber identifier (local IF ID=#2; remote IF ID=#1) and the updated ring ID=N2 in the Link Summary Message 40 to be transmitted to the other neighbor node N6.
Step S28: As with the above noted step S14, the node N6 also stores the fiber identifier (local IF ID=#2; remote IF ID=#1) and the ring ID=N6 in the Link Summary Message 30 to be transmitted to the neighbor node N1, where the same information is transmitted to the node N5 as well while not depicted in operation.
Step S29: The node N1 compares the ring ID=N6 stored in the Link Summary Message 30 transmitted from the node N6 with the ring ID=N2 (updated value) assigned to the fiber F2 at step S26. Supposing that N2<N6 is found, the ring ID is updated to N6.
Step S30: The node N1 stores the fiber identifier (local IF ID=#2; remote IF ID=#1) and the updated ring ID=N6 in the Link Summary Message 50 to be transmitted to the other neighbor node N2.
Step S31: The node N2 compares the ring ID=N6 stored in the Link Summary Message 50 transmitted from the node N1 with the ring ID=N2 assigned to the fiber F3, in which since N2<N6 is found, the ring ID is updated to N6.

It is to be noted that while the node N6 compares the ring ID=N2 stored in the Link Summary Message 40 transmitted from the node N1 with the ring ID=N6 assigned to the fiber by the node N6 itself, N2<N6 is found, so that the ring ID is not updated.

By repeating the same operations, to all of the fibers within the ring R1 the ring ID=N6 is to be automatically assigned.

### Operation Example [2]

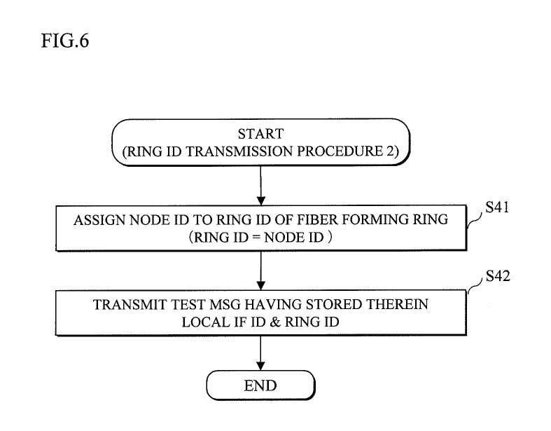

### FIGS. 6-8

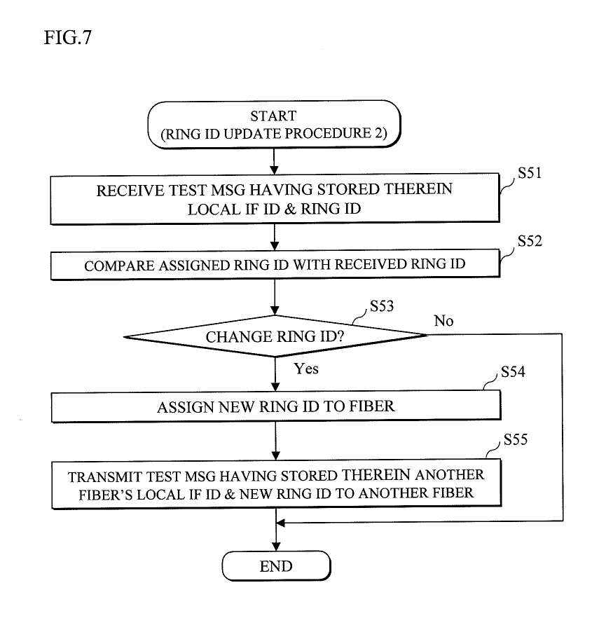

In this operation example, the node N depicted in FIG. 1 operates along the flow charts depicted in FIGS. 6 and 7.

### <Ring ID Transmitting Procedure 2: FIG. 6>

First, FIG. 6 depicts the following transmitting operation right after the start-up:

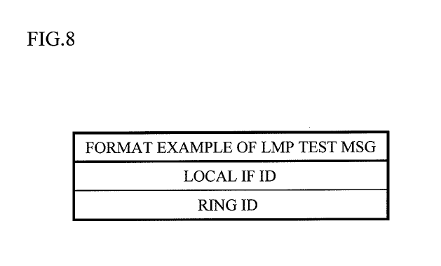

Step S41: After the start-up, each node assigns the node ID (initial value) of the node itself to the ring ID of the fiber in the same manner as the above.
Step S42: For the Link Verification of LMP (Link Management Protocol), the test message is transmitted into the fiber. This test message is added with, as depicted in FIG. 8, not only the local IF ID to which the fiber is connected but also a new ring ID. In this ring ID, the initial value (node ID of the node concerned) already assigned at step S41 is stored.

### <Ring ID Update Procedure 2: FIG. 7>

FIG. 7 depicts the following ring ID update operations at the time of receiving the Link Summary Message:

Step S51: The test message having stored therein the fiber identifier (local IF ID and ring ID) at the above step S42 is received.
Step S52: The ring ID already assigned at step S41 to the fiber having received the test message is checked or compared with the ring ID received, where for example a larger ring ID (or smaller ring ID) is selected.
Step S53: Namely, if the ring ID received is smaller and so is not selected, the processing will end; if the ring ID received is larger and so is made a new ring ID, the following steps will be executed.
Step S54: The ring ID received is assigned to the fiber.
Step S55: The test message having stored therein the local IF ID to which the fiber is connected and the ring ID updated is transmitted to the fiber on the other side of the ring.

It is to be noted that while it has been described in the foregoing and depicted in FIG. 8 that the local IF ID is stored in the test message since the LMP specification prescribes that the local IF ID be stored in the test message, this ring ID-automatic assigning process does not use this local IF ID because only the recognition of the fiber having received the test message enables the ring ID to be assigned to the fiber.

### Operation Example [3]

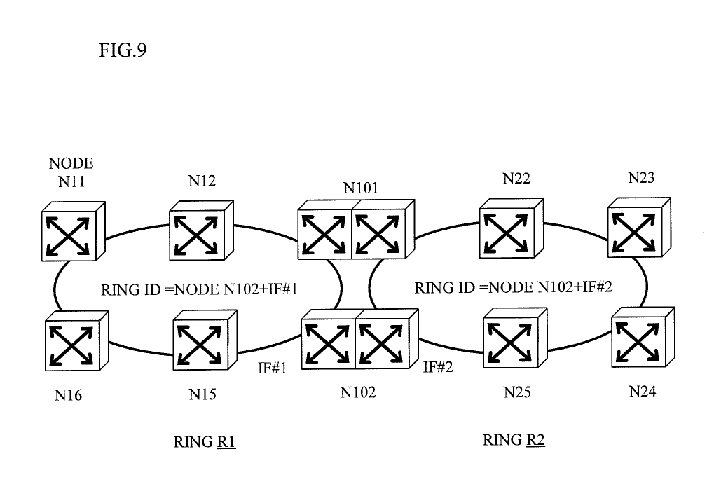

### FIG. 9

In a case where each of nodes N101 and N102 belongs to a plurality of ring networks R1 and R2 as depicted in FIG. 9, there is a possibility that assignment of the ring ID with the node ID being made a reference will lead to assignment of the same ring ID between the rings R1 and R2. For example in the case of FIG. 9, the node N102 has the largest node ID in either the right ring network R2 or the left ring network R1, so that the ring ID=N102 results in being assigned to all of the fibers belonging to both of the ring networks R1 and R2.

Therefore, this operation example [3] solves this problem by using a ring ID in which the node ID is combined with the local IF ID. For example, if the node ID has a value of 32 bit length and the local IF ID has a value of 16 bit length, a ring ID unique to each ring can be obtained by expressing the ring ID with a value of 48 (=32+16) bit length.

### Operation Example [4]

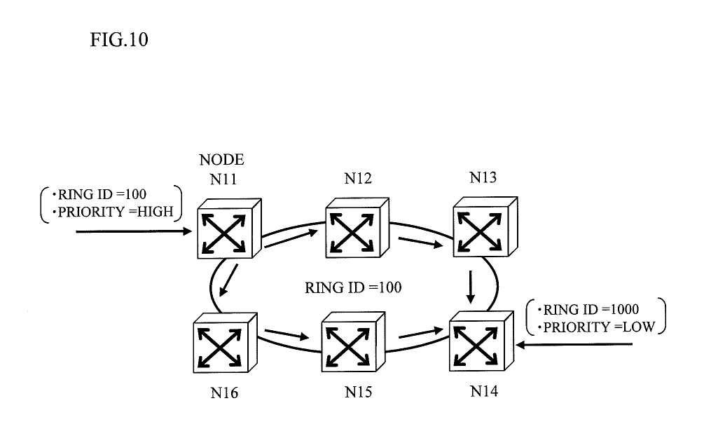

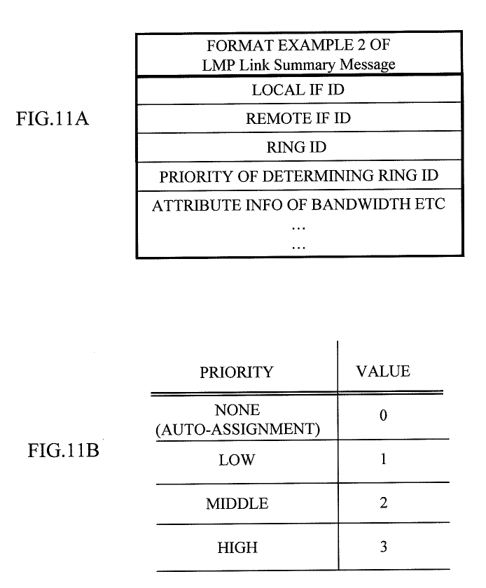

### FIGS. 10 and 11

According to the above operation examples [1]-[3], all of the ring IDs are automatically assigned by using a node ID or node ID+local IF ID. However, there is a case where a number the network manager can easily manage is desired to be assigned as the ring ID.

Therefore, priority information is used together with the ring ID to be notified. Along the above operation example [1], the processing of a case where the priority information is used will now be described. Namely, the Link Summary Message used in the operation example [1] is extended to store “Priority of determining ring ID” as depicted in FIG. 11A, where the priority is defined as depicted in FIG. 11B.

### <Ring ID Transmitting Procedure 3>

The transmitting operations right after the start-up in this operation example [4] are as follows, where the following 1)-3) respectively correspond to steps S1-S3 in the operation example [1], while having different portions underlined:

1) As the ring ID of each two fibers (four fibers in total) on both sides of a node, the node ID (initial value) of the node itself is assigned. At the time of start-up, “Priority of determining ring ID” is automatically set to “0”, where the priority is substantially invalid. Then, the network manager enters the priority together with the ring ID. In this case, if a plurality of rings are mutually associated, one of the rings is designated. It is to be noted that “Priority of determining ring ID” may not be directly entered but each node may assign a default priority, which is to be stored in the information database 3:
2) The known “Link Verification” function of LMP (Link Management Protocol) is started up. With this Link Verification function, the test message having stored therein the local IF ID of a node concerned to which the fibers are connected is transmitted into the fibers from the control message generating portion 4 through the control message transmitting portion 5. When the test message is received by the control message receiving portion 1, the local IF ID of the fibers having received the test message is stored as a remote IF ID in the test message to be returned by the control message generating portion 4. Consequently, the correspondence between the local IF ID and the remote IF ID of the fibers can be recorded in the information database 3;
3) The “Link Property Correlation” function of LMP is started up. By this Link Property Correlation function, the combination of the local IF ID and the remote IF ID as the fiber identifier obtained at the above step S2 as well as the attribute information (support protocol, bandwidth etc.) of the fibers are read out of the information database 3 and stored in the Link Summary Message, as the control message depicted in FIG. 4, to be transmitted to the neighbor node by the control message generating portion 4. At this time, the ring ID assigned as one of the attribute information of the fibers in the above 1) and “Priority of determining ring ID” are read out of the information database 3 and added to the Link Summary Message (see FIG. 11A) to be transmitted.

### <Ring ID Update Procedure 3>

The ring ID update operation at the time of receiving the Link Summary Message will now be described. In this procedure example, the following 1)-5) respectively correspond to steps S11-S15 in the operation example [1], while having different portions underlined:

1) The Link Summary Message having stored therein the local IF ID, remote IF ID and ring ID as well as “Priority of determining ring ID” is received from the control message receiving portion 1;
2) The local IF ID and remote IF ID of the Link Summary Message received are extracted by the ring ID determining portion 2 and “Priority of determining ring ID” of the fiber corresponding to these IF IDs, which may be a priority assigned by the network manager, is read out of the link information data base 3 and compared with “Priority of determining ring ID” extracted from the Link Summary Message received (priority assigned by the network manager on the transmitting side). It is to be noted that as described in 1) of the above ring ID transmitting procedure 3, when it is set at each node that “Priority of determining ring ID”=0, the priority is identical with each node and so is not required to be compared:

As a result of the comparison, if it is found that “Priority of determining ring ID” received is smaller, the processing will end. If it is larger, the ring ID assigned on the receiving side of the fiber identified with the local IF ID and the remote IF ID received is compared with the received ring ID assigned on the transmitting side. For example, a larger ring ID (or smaller ring ID) is to be selected.

3) Namely, if the ring ID received is smaller and so is not selected, the processing will end. If the ring ID received is larger and so is updated to a new ring ID, the ring ID determining portion 2 further executes the following steps:
4) A new ring ID received is assigned to the fiber;
5) The control message generating portion 4 starts up the Link Property Correlation of LMP and stores the fiber identifier (local IF ID and remote IF ID) already obtained with respect to the other neighbor node forming the ring, the ring ID assigned in the above 4) and “Priority of determining ring ID” received in the Link Summary Message to be transmitted to the neighbor node from the control message transmitting portion 5, where another attribute information may be transmitted together.

Thus, in the case depicted in FIG. 10, the ring ID=100 assigned by the network manager at node N1 has a priority higher than the ring ID=1000 assigned by the network manager at node N14 even though the ring ID is smaller, so that the ring ID is to be assigned “100”, which indicates that by being inputted from a single node, the same ring ID is to be assigned over the entire ring.

### Operation Example [5]

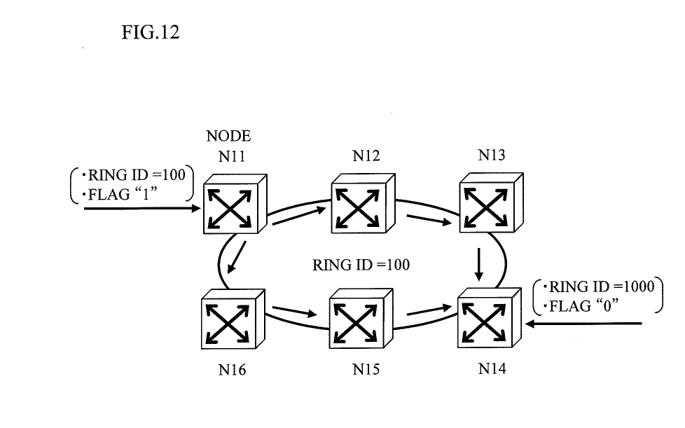

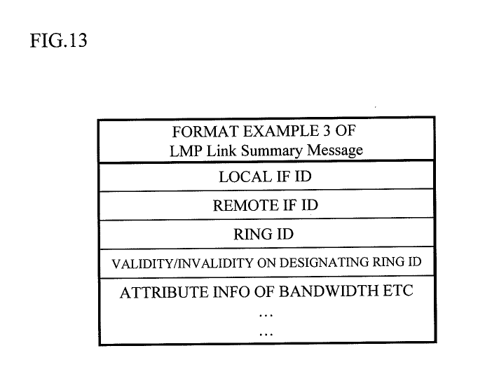

### FIGS. 12 and 13

The above operation example [4] uses a priority for the network manager to assign an easily manageable number as the ring ID. This priority achieves an effect when a plurality of network managers assign a ring ID.

However, as depicted in FIG. 12, when a plurality of ring IDs are not designated at the same time, also by using a flag indicating validity or invalidity of designation of ring ID by the network manager, an equivalent measure can be achieved.

Namely, even though the node N14 has a larger ring ID than the node N1, the ring ID=1000 of the node N14 in which the flag is set “0” becomes invalid, so that as with the example of FIG. 10, the ring ID=100 of the node N11 is to be assigned over the entire ring.

For this purpose, the Link Summary Message used in the operation example [1] is extended to store a flag of “validity/invalidity on designating ring ID” as depicted in FIG. 13.

Upon receiving the Link Summary Message, after the evaluation of the “ring ID designation validity/invalidity” flag is executed, the ring ID is evaluated to determine necessity of updating the ring ID.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

1. A method of assigning ring identifier comprising:
transmitting a control message having stored therein a link identifier for identifying a link and a ring identifier for identifying a ring to a neighbor node;
selecting either one of a ring identifier preliminarily assigned to a link identified by the link identifier received from the neighbor node and a ring identifier received from the neighbor node according to specified selection criteria; and
assigning the ring identifier selected to the link identified.

2. A method of assigning ring identifier comprising:
providing a control message having stored therein a ring identifier to a neighbor node;
selecting either one of a ring identifier preliminarily assigned to a link having received the control message and a ring identifier in the control message according to specified selection criteria; and
assigning the ring identifier selected to the link identified.

3. The method of assigning ring identifier as claimed in claim 1, wherein an initial value of the ring identifier comprises a node identifier or a node identifier+a local interface identifier, and the specified selection criteria comprise criteria for selecting a larger one or a smaller one of the node identifier or a node identifier+a local interface identifier.

4. The method of assigning ring identifier as claimed in claim 1, wherein the control message comprises a Link Summary Message based on a Link Property Correlation function of a Link Management Protocol.

5. The method of assigning ring identifier as claimed in claim 2, wherein the control message comprises a test message based on a Link Verification function of a Link Management Protocol.

6. The method of assigning ring identifier as claimed in claim 1, wherein the ring identifier is provided by a network manager together with a flag indicating a priority or a validity/invalidity thereof and then stored in the control message; and
the selecting comprises selecting the one of the ring identifiers according to the specified selection criteria in view of the priority or flag stored in the control message.

7. A device of assigning ring identifier comprising:
a portion to transmit a control message having stored therein a link identifier for identifying a link and a ring identifier for identifying a ring to a neighbor node;
a portion to select either one of a ring identifier preliminarily assigned to a link identified by the link identifier received from the neighbor node and a ring identifier received from the neighbor node according to specified selection criteria; and
a portion to assign the ring identifier selected to the link identified.
